(19) United States
(12) Patent Application Publication
(10) Pub. No.: US 2005/0176321 A1
(43) Pub. Date: Aug. 11, 2005

(54) Fiber wear layer for flooring and other products

(76) Inventors: Stephanie A. Crette, Charleston, SC (US); Inez N. De Oliveira, Mount Pleasant, SC (US); Mark A. Johnson, Chillicothe, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 11/070,609

(22) Filed: Mar. 2, 2005

Related U.S. Application Data
(63) Continuation-in-part of application No. 10/684,913, filed on Oct. 14, 2003.

(51) Int. Cl. B32B 5/02; B32B 27/04

(52) U.S. Cl. 442/103; 442/148; 442/153; 442/154; 442/155

(57) ABSTRACT

A laminar product comprising an overlay and a base layer, the overlay including a fibrous web impregnated with a radiation curable saturating resin, the base layer being a resilient resin layer or a felt or matted layer. In one embodiment, the radiation curable saturating resin includes a reactive silicone acrylate oligomer. Radiation curable compositions containing a silicone acrylate are also disclosed.

### CROSS-REFERENCE TO RELATED APPLICATIONS

This application is a continuation-in-part of U.S. application Ser. No. 10/684,913 filed Oct. 14, 2003.

### BACKGROUND OF THE INVENTION

The present invention is directed to a laminar product and, more particularly, to a laminar product having an overlay impregnated with a saturating resin laminated to a base layer. In a more particular embodiment, the saturating resin is a radiation curable saturating resin and in a still more particular embodiment it is a radiation curable resin containing a reactive silicone acrylate oligomer. The laminar product of the invention is particularly useful as flooring, wallboard, and the like.

Wear resistant overlays have been used effectively in manufacturing decorative laminates. These overlays are well known in the art. They are typically formed from a cellulosic fiber web and, more particularly, a low basis weight alpha cellulose paper which incorporates an abrasion resistant filler or grit. When the paper and grit matrix is saturated with the resin, the resin wets the surface of the grit and the fiber and the overlay becomes transparent as a result of the similar indices of refraction of the materials. Examples of wear resistant overlays can be found in U.S. Pat. No. 3,798,111 to Lane; U.S. Pat. No. 4,713,138 to Ungar; U.S. Pat. No. 5,141,799 to Mheta; U.S. Pat. No. 5,268,204 to Hill et al. among others.

Floor, wall, and ceiling coverings are also well known. In many cases these coverings are manufactured from polyvinyl chloride resins. To impart wear resistance, the coverings are over coated with a clear liquid or semi-liquid wear-resistant resinous composition. Typical resins used in these wear resistant layers are vinyl resins, polyurethanes or acrylated polyurethane resins. While these resinous wear layers have been somewhat effective, new wear layers are desired having improved abrasion and scuff resistance and improved dimensional stability.

### SUMMARY OF THE INVENTION

The present invention provides a laminar product having a resin impregnated overlay laminated to a base layer. In accordance with one embodiment of the invention, the base layer is a resilient resin layer of the type used in such products as vinyl composition tile (VCT) or vinyl or linoleum flooring products including loose lay and tension flooring products. In accordance with another embodiment of the invention, the base layer is a felted or matted fibrous sheet. In still another embodiment of the invention, a floor covering is provided which comprises a resin impregnated overlay paper, a layer of a foamed polyvinyl chloride (PVC) resin, and a felt layer.

In accordance with one embodiment of the invention, in order to impart decorative characteristics to the laminate a print layer may be associated with either the felted or matted base layer or the foamed resin layer. Alternatively, in lieu of or in addition to incorporating a print layer into the laminate, decorative inclusions may be included in the resilient resin layer, the felted or matted base layer or the foam layer. In still another embodiment of the invention, the print layer may be incorporated on the back (inside) surface of the overlay.

In accordance with another embodiment of the invention, the saturating resin is a radiation curable resin composition and, more particularly, a composition containing a reactive silicone acrylate oligomer.

In another embodiment, the invention is a method for forming a wear layer on a base layer, the base layer being a resilient resin layer or a felt or matted layer or a wood layer which comprises; impregnating a cellulose web with a radiation curable saturating resin, placing the resin-impregnated web on the base layer, and exposing the resin-impregnated resin to radiation.

In another embodiment of the invention, radiation curable impregnating resin compositions are provided. In one particular embodiment, the composition includes a reactive silicone acrylate. In another embodiment, the composition includes a reactive silicone acrylate oligomer, and a cyclic polyfunctional acrylate. In another embodiment, the composition includes a reactive silicone acrylate oligomer, a cyclic polyfunctional acrylate and an alkoxylated acrylate. These compositions can be cured by electron beam or by UV or visible radiation with the addition of a photoinitiator. The compositions can be used as impregnating resin compositions for overlays as described above, but the compositions can also be used as a simple wear layer, i.e., not impregnated into a cellulose web and cured in situ by radiation.

### BRIEF DESCRIPTION OF THE DRAWINGS

FIG. 1 is a cross section of a laminar product in accordance with one embodiment of the invention.

FIG. 2 is a cross section of a floor covering in accordance with another embodiment of the invention.

FIG. 3 is a cross section of a laminar product in accordance with an embodiment of the invention in which the base layer is a felted or matted base layer.

FIG. 4 shows a typical process for manufacturing the laminate of the present invention.

### DETAILED DESCRIPTION OF THE INVENTION

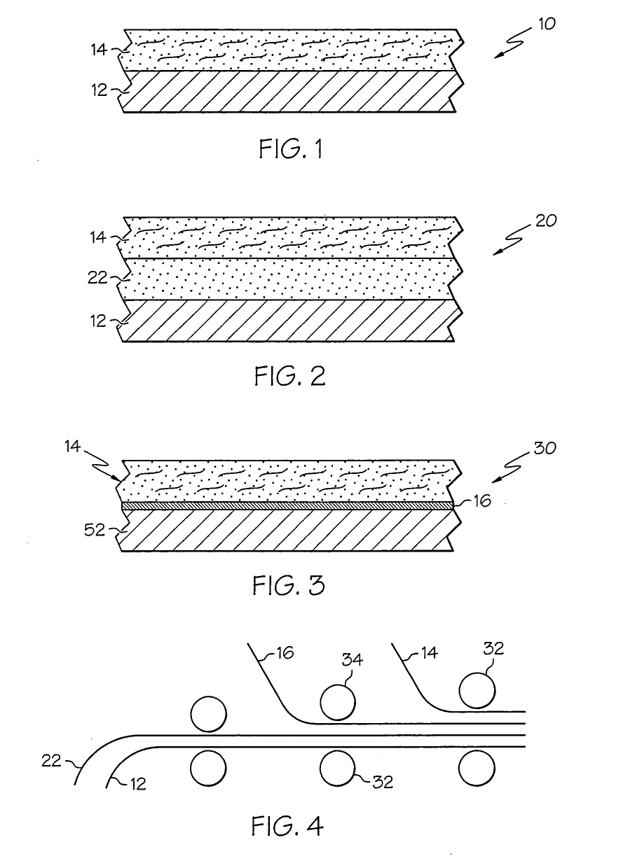

In accordance with the invention, the wear characteristics of various laminar products are improved by incorporating a resin-saturated fiber overlay onto the surface of the product. FIG. 1 illustrates a laminar product in accordance with one embodiment of the invention. This laminar product 10 is made up of a base layer 12 and an overlay 14. In accordance with one embodiment of the invention, the base layer 12 is a resilient resin layer of the type used in such products as vinyl flooring, vinyl composition tile (VCT), printed cushioned roto vinyl sheet, roto vinyl tile, stencil inlayed sheet, calendared inlayed sheet, homogenous vinyl sheet, linoleum, heterogenous vinyl sheet, luxury vinyl tile. In accordance with the invention the resin-saturated fiber overlay is bonded to any of the foregoing substrate or base layers to provide a product having improved wear and/or scuff resistance and/or improved dimensional stability.

FIG. 2 illustrates an embodiment of the invention in which the laminar product 20 is a product such as flooring and includes a resilient resin base layer 12, a foamed resin layer 22 and a wear-resistant overlay layer 14. In the illustration, a print layer 16 is incorporated in the product 20 between the foamed layer 22 and the overlay layer 14 but the print layer is optional. The print layer 16 can be applied to the overlay or the print layer can be applied to the foam layer.

In one embodiment of the invention improved vinyl composite tile is provided. The structure shown in FIG. 1 is the structure of a vinyl composite tile when the base layer 12 is a composite of a resin, such as a vinyl resin, and a filler such as ground limestone. In accordance with the invention, the wear and scuff resistant characteristics of the tile are improved by bonding or adhering the saturating resin-impregnated paper overlay to the exposed surface of the base layer 12, which in this case is the limestone-resin composite.

FIG. 3 illustrates a further embodiment of the invention in which the laminar product 30 includes a felt or matted base layer 52 and a saturating resin impregnated overlay 14. In accordance with the illustrated embodiment, a print layer 16 is formed on the surface of the felt or matt layer 52. Alternatively, as discussed elsewhere herein, decorative inclusions can be incorporated directly in the base layer 52 in lieu of a print layer.

The overlay 14 can be formed from any natural or synthetic fiber. In particular any of the fibers conventionally used in natural and synthetic paper products may be used. In one embodiment the overlay 14 is a composite of a low basis weight cellulose fiber paper of the type conventionally used in forming overlays in the decorative laminating field, and a saturating resin which impregnates the overlay. One of the most common fibers used in overlays is alpha cellulose or mixtures thereof with other cellulose fibers, e.g., a highly bleached fibrous cellulosic pulp and/or alpha pulp beaten to a Canadian Standard Freeness of about 500 ml. The cellulose fibers used in the overlay are preferably bleached Kraft pulp, although any fiber used in conventional overlay sheets may be employed. The pulp may consist of hardwoods or softwoods or a mixture of hardwoods and softwoods. Higher alpha cellulose such as cotton may be added to enhance characteristics such as post-formability. Overlay sheets useful in the present invention are known in the art. Examples of overlay sheets in addition to those cited above can be found in Canadian Patent 990,632 and U.S. Pat. Nos. 3,135,643; 3,445,327; 3,525,664; 3,798,117; and 3,975,572.

The overlay paper typically has a basis weight of about 15 to 30 pounds per 3,000 square feet without pigment filler. With pigment (discussed later), the basis weight is about 20 to 50 pounds per 3,000 square feet.

The fibers forming the overlay and the saturating resin are selected such that their respective indices of retraction closely match such that the overlay transparentizes when it is dried and cured. Examples of saturating resins that may be impregnated into the overlay fibers include vinyl chloride resins, acrylics (rmorez 2955 available from MeadWestvaco Specialty Chemicals) polyurethanes, and acrylated polyurethanes. Preferably a resin is selected which enhances the scratch and abrasion resistance of the laminate. Two polyurethanes that are particularly useful in the invention are HD 2209 and HD 2107 which are polyester polyurethanes that are available from Hauthane as waterborne compositions. Conventional polyurethane resins are reaction products of one or more polyols or (or polyamines=polyureas) and one or more polyisocyanates. Examples of polyurethanes are well known in the art. Acrylated polyurethanes can be prepared by the methods described in U.S. Pat. No. 4,100,318. Other examples of potentially useful resins are diallyl phthalate polyester (DAP) resin described in JP7256818 (1995); thermoplastic polyurethane (TPU) film by melt molding described in U.S. Pat. No. 5,821,180 (1998) and U.S. Pat. No. 6,592,692 (2003); crosslinkable electronic beam (EB) and UV-curable epoxy resins, polyester-polyurethane resins described in U.S. Pat. No. 6,333,076 (2001); UV-crosslinkable brushable PVC-acrylate hybrid resins described in DE Patent 3543266 (1986) and polyurethane (meth)acrylate resins described in U.S. Pat. No. 5,843,576 (1998); alkylated melamine resin-polyurethane blend described in U.S. Pat. No. 5,643,677 (1997); moisture curable polyurethane-ureas described in U.S. Pat. No. 5,140,088 (1992); epoxy/silicate hybrid organic/organic wearlayer described in U.S. Pat. No. 5,023,140 (1991); melamine/polyol/cellulose acetate wearlayer described in U.S. Pat. No. 4,983,466 (1991); and organosilicon wear layer polymer described in CA Patent 2164062 (1997).

Normally, the resin will be impregnated into the laminate in the form of a solution or dispersion such as an aqueous solution or a solvent-base solution. It may also be feasible, in some cases, to impregnate the resin into the overlay in the form of a melt. In one potential embodiment, the wear-resistant resin can be provided in the form of a film which is juxtaposed with the overlay and heated to melt the film such that it impregnates the overlay. For example, plasticized PVC film can be press molded into overlay fibers using procedures outlined in Japanese Patent 53094576. Alternately, paper can be coated with liquid PVC polymer prior to press molding according to Gagne U.S. Pat. No. 4,041,197 (1977) or Werner, A. C., Vinyl Plastisol and Organosol Coatings for Paper. Tappi J. 50(1):79A-84A. 1967 3. Another method for melt molding polyurethane into an overlay is described in U.S. Pat. No. 5,821,180. The resin is typically incorporated in the overlay in an amount of about 50% to 400% based upon dry weight of the paper.

After impregnating the resin into the overlay, the overlay is assembled with the laminate to provide the structures illustrated in FIGS. 1-3. In accordance with one embodiment of the invention, the resin-impregnated overlay is assembled with the base layer or the foam layer while the resin-impregnated overlay is wet and the overlay is cured in place on the surface of the laminate. In this embodiment, as the overlay cures, the overlay bonds to the underlying base layer 12 or foam layer 22. This is particularly useful when the impregnating resin is a polyurethane.

In another embodiment of the invention, the resin impregnated overlay is cured (e.g., dried or crosslinked) prior to assembly with the base layer and thereafter the cured overlay is bonded to the surface of the base layer 12 or the foam layer 22 using a suitable adhesive. Examples of adhesives that may be useful in bonding the overlay to form the laminate include cyanoacrylates, hot melt adhesives and water borne polyurethane adhesives. Those skilled in the art will appreciate that substantially any adhesive that is waterproof and compatible with the properties of the resin impregnated overlay and the base sheet can be used in the invention.

In various products, to make the laminate aesthetically appealing, the laminate includes a print layer including any desirable decorative pattern or image. The print (decorative) layer may consist of a layer of ink or solid inclusions, metal flakes, polyester glitter, colored wax, colored PVC particles or core-shell particles, nacreous pigment, resin particles, natural materials such as leaves, stems, flowers petals, grasses, paint chips, confetti paper, colored quartz chips or other minerals, colored glass particles, twine, string, bark, wood flour, or cork. In one embodiment an image simulating wood appearance may be used. Alternatively, decorative inclusions may be incorporated directly in the base layer 12 alone or with the print layer. Decorative inclusions include decorative elements known in the art such as pearlescent pigments, metal particles and shavings, and any of the decorative additives used in making decorative laminates or flooring materials. In VCT, a print layer is not normally used. The decorative elements are incorporated in the composite forming the tile.

In a particular embodiment of the invention, the print layer may be formed on the back surface of the overlay 14 such that the print layer is incorporated into the laminate 10 with the overlay 14 when it is assembled with the base layer 12 as described later herein.

The thickness of the base layer 12 will be comparable to thicknesses routinely encountered in the vinyl flooring and decorative laminating arts. For example, the base layer 12 that is found in many vinyl flooring products is usually about 80 to 150 mils thick. In VCT the composite layer is usually about 100 to 125 mils thick. One of the advantages of certain embodiments of the invention is that it permits the thickness of the wear layer to be reduced. Conventionally wear layers in vinyl flooring products may range from approximately 5 to 16 mils thick. Because the wear layer of the present invention is reinforced with fiber such as cellulose, the layer provides improved structural integrity. The layer is less likely to chip or tear upon cutting. Consequently, in certain embodiments of the invention, it is possible to use overlays that may be as thin as about 1 to 3 mils thick. However, in other embodiments of the invention, the overlay may range from about 2 to 5 mils think.

In accordance with the invention, resin saturated overlays are combined with any of a variety of the base layers used in floor and wall products. The preferred and most widely used resin for the foamed layer 22 is PVC. The PVC can be a homopolymer of vinyl chloride, or copolymers, terpolymers, or the like. Examples of vinyl chloride homopolymers, copolymers, and terpolymers that have been used in the manufacture of foamed layers are provided in U.S. Pat. No. 4,264,643 which is incorporated herein. While vinyl chloride resins are preferred for use in the foamed layer 22, it will be apparent to those skilled in the art that the layer 22 can be formed from any resin which can be foamed with a blowing agent. Other resins which may be useful include polyethylene, polypropylene, methacrylates, rubbers, polyurethanes, and the like. Other examples of resins that may used in forming the layer 22 are provided in aforementioned patent.

The layer 22 can be formed by applying a plastisol to the surface of the felt layer 42. Conventionally, these plastisol compositions contain 20 to about 150 parts plasticizer per 100 parts resin. Useful plasticizers are well known in the art. This foamable composition is typically a dispersion of a resin in a plasticizer, i.e., a plastisol. The preferred and most widely used plastisols are polyvinyl chloride (PVC). In accordance with the invention an overlay that has been impregnated with a wear resistant resin is bonded to the outer surface of the foamed PVC to provide a wear layer on the top surface of the laminate. The compositions additionally contain an effective amount of a blowing agent. The amount of the blowing agent is adjusted depending upon the density of the foam that is desired. Examples of useful plastisols, plasticizers, and blowing agents are provided in U.S. Pat. No. 4,264,643 and U.S. Application 20020127372.

Vinyl composite tile layers are made up of ground limestone and/or ground ceramics and resins such as polyvinyl chloride (PVC), or PVC replacements or substitutes such as described in U.S. Pat. No. 5,910,358 and U.S. 20030166754 (polyolefins), ionomeric resins as described in U.S. Pat. No. 5,728,476, polyacrylate/chlorinated polyethylene as described in U.S. Pat. No. 4,083,821, DuPont's Surlyn ionomeric resin as described in WO 95/11333, acrylate plastisols as described in EP 0342562, ethylene vinyl acetate copolymer as described in EP 0528194, or melt processable non-platstisols as described in U.S. Pat. No. 6,511,926. Other resilient flooring types also may include these resins with different fillers, plasticizers, antioxidants, antistatic agents and colorants. Other resilient flooring types include those based on cork, rubber or linoleum which is a natural material of epoxidized linseed oil and wood flour, cork filler and colorants. Any of these flooring types may be covered with a saturated paper wear layer as described here, even if they are not normally produced with a wear layer during manufacturing.

Other embodiments of the invention include saturated paper wear layers applied on non-resilient flooring such as cement or concrete flooring, ceramic tile, hardwood, plywood, particle board, wood veneer flooring and engineered wood (including plywood and OSB), including but not limited to those flooring types described in CN 1381342, U.S. Pat. No. 4,210,692, U.S. Pat. No. 3,551,272, GB 1115942, U.S. Pat. No. 4,541,880, U.S. Pat. No. 3,666,593, U.S. Pat. No. 5,116,446, U.S. Pat. No. 5,143,418, U.S. Pat. No. 6,497,937, KR 2001004829, U.S. Pat. No. 5,925,211, GB 1197229, U.S. Pat. No. 4,083,743, and U.S. Pat. No. 1,597,539.

Wear layers added during manufacturing are known to reduce the repeated labor and material costs of flooring maintenance with temporary waxes, acrylics or other polymers over the life of the floor. These wear layers also add greater ease of cleanability, antisoiling and improved stain resistance. Silylated acrylic polymers may be added to the saturating polymer mixture to improve cleanability similar to those described in JP 2003237008, JP 2003039622 and JP 2003225985.

In accordance with one embodiment of the invention, the overlay sheet contains an abrasion resistant mineral pigment. While those skilled in the art will appreciate many abrasion-resistant pigments can be used in the present invention the preferred pigments have a Mohs hardness of at least about 3, preferably at least about 5. In one embodiment of the invention a pigment filler as described in U.S. Pat. RE 30,233 may be used. This pigment has a Mohs hardness greater than 6.0 and an average particle size of about 30 to 100 microns. Representative examples of mineral pigments that may be used include silica, alumina, titanium oxide, tin oxide, zirconium oxide, and the like. In a particular embodiment of the invention, the wear resistant pigment is a rounded grain quartz (Wedron 710 available from Fairmount Minerals). An abrasion resistant filler may be incorporated in the overlay in an amount up to about 40 grams per square meter and preferably about 5 to 30 grams per square meter.

The abrasion resistant filler may be incorporated into the overlay using a number of techniques. One technique involves mixing the pigment with a paper furnish from which the overlay is formed on the paper making machine. Another technique involves adding an aqueous slurry of the pigment to the surface of the wet paper web through a secondary head box of a papermaking machine. The slurry of mineral particles cascades over and through the cellulose fibers and causes the particles to become embedded in the overlay. Another method that can be used to deposit the mineral particles involves use of a slot orifice coater and is described in U.S. Pat. No. 5,820,937. Still another method for preparing the abrasion-resistant particle-containing overlay is described in U.S. Pat. No. 6,287,681. In a further embodiment of the invention, the overlay 12 is actually made up of three sublayers, namely, a first layer of cellulose, a layer of abrasion resistant particles, and a second layer of cellulose fibers. The layers of cellulose fibers sandwich and entrap the intervening layer of mineral pigment. This overlay can be manufactured as described in U.S. Pat. No. 6,551,455. This overlay is particularly amenable to backside printing because the mineral pigment is shielded from the print layer.

With reference more specifically to the structure shown in FIG. 3, examples of this felted or matted base layer are described in U.S. Pat. No. 4,225,383 to McReynolds which is incorporated herein by reference. In accordance with a particular embodiment of the invention, the felted or matted base layer is formed from cellulose fiber. The felt layer can be manufactured using conventional equipment for felt manufacture. Conventionally, a water dispersible fiber is admixed with water to provide an aqueous dispersion containing from about 5 to 15 percent water-dispersible fiber using a hydropulper. A finely-divided filler may be admixed with the fiber in the hydro-pulper. The mixture is blended with an organic polymer in the form of a latex which is flocculated to form a fibrous agglomerate that is formed into a web on a papermaking machine. Base layers have been formed from any water insoluble, natural or synthetic water-dispersible fiber including wood pulp, glass fiber, cotton and linen rag, and synthetic pulp. Particularly useful fibers are cellulosic and lignocellulosic fibers commonly known as wood pulp of various kinds from hardwood and softwood such as stone ground, mechanical, chemimechanical, chemical, and semichemical pulp. More specifically bleached or unbleached sulfite and sulfate pulps may be used.

The fillers that may be used in the base layer include any of those conventionally used in the art including calcium carbonate, titanium dioxide, and the like. The binder used in forming the felted layer may be natural or synthetic and may be a homopolymer or copolymer. Preferably the polymer is a latex. Representative polymers are acrylics, polyvinyl acetates, natural rubber, synthetic rubbers, etc. A representative example of manufacture of the laminate is illustrated schematically in FIG. 4 for the flooring of FIG. 2. This process can be used with appropriate modification manufacturing other laminar products. Typically a felt 12 and a foamed plastisol sheet 22 will be bonded together and assembled with a print sheet 16. The print sheet can be printed using a rotogravure print roll 34. The pressures and temperatures required to accomplish each of these operations are well known in the art. The overlay 14 is fed to the laminate and bonded in place using a heated roll 36. The overlay can be bonded to the felted base sheet or the foamed layer using various different techniques. In one embodiment of the invention, the resin-impregnated overlay is assembled with the base sheet 12 or the foamed sheet 22 while the overlay is wet and the assembly is heated to drive the water or solvent from the resin-impregnated overlay whereupon the overlay becomes bonded to the underlying substrate. In another embodiment of the invention, the resin-impregnated overlay is cured. Curing can consist of drying the overlay or inducing cross-linking reactions that harden the resin within the overlay. In this instance, the cured overlay is assembled with the underlying substrate by means of any of the adhesives previously discussed. Generally, the amount of heat and pressure required to bond the overlay to the underlying substrate is not extreme. Pressure is deliverable from a conventional pressure roller, for example, about 2 to 40 pli, and temperatures of about 100 to 200° C. are sufficient to effect bonding to the substrates.

One of the advantages of using saturating resin-impregnated overlays in these laminar products such as flooring products is the embossability of the overlay. With reference to FIG. 4, the heated roll 36 that is used to bond the laminate together or a dedicated embossing roll can have a smooth finish or a textured or ornamental finish. Upon contacting the overlay with the heated roll 36 under appropriate temperature and pressure conditions, the pattern on the surface of the roll 36 will be imparted into the overlay which upon curing retains the desired texture or ornamental appearance.

In certain embodiments of the invention, the impregnating resins are radiation curable resins and more particularly UV curable impregnating resin compositions. In further embodiments, the radiation curable compositions are liquid at room temperature so that the overlay can be impregnated without additional heating. One advantage of the radiation curable resin compositions used in selected embodiments of the invention is that they can be formulated in a viscosity that readily impregnates the paper. By contrast, certain thermally cured impregnating resins compositions are viscous and/or they contain polymer particles with much higher molecular weights and require that heat and vacuum are used in some manufacturing processes to impregnate the overlay. While, more viscous compositions can be used in some embodiments of the invention, embodiments in which the uncured resin formulation is liquid at room or ambient temperature are particularly desirable. In one embodiment of the invention, the radiation curable resin composition is impregnated into the overlay paper, applied to a substrate and cured. In another embodiment, the resin composition may be impregnated into the overlay paper and partially cured, then applied to a substrate and fully cured.

Reactive oligomers that may be employed in the radiation curable compositions used in one embodiment of this invention include substantially any polymeric material characterized by the presence of at least one, preferably at least two, ethylenically unsaturated unit(s), and which is curable through a free radical-induced polymerization mechanism. Suitable oligomers include acrylourethane oligomers, polyester acrylate oligomers, epoxy acrylate oligomers, isocyanurate acrylates, melamine acrylates, and reactive silicone acrylate oligomers. The oligomer typically comprises from about 10 to about 90 wt. %, and in other embodiments from about 30 to about 50 wt. % of the total radiation curable impregnating composition. By the term “reactive silicone acrylate oligomers” is meant polymeric siloxanes and silicone resins displaying acrylate functionality including but not limited to acrylated polysiloxanes, and acryl modified polysiloxanes.

In the preparation of a radiation-curable coating composition, the oligomer is typically utilized in combination with a reactive monomer diluent to adjust the viscosity of the composition to the desired level for impregnating. Reactive monomers which can be used alone or in combination with reactive oligomers as reactive diluents for such oligomers are well known. Suitable reactive monomer diluent systems comprise at least one unsaturated addition polymerizable monomer which is copolymerizable upon exposure to radiation.

The reactive monomer diluent can be monofunctional or polyfunctional, e.g. di-, tri- or penta-functional. A single polyfunctional diluent can be used, as can mixtures thereof; or a combination of one or more monofunctional reactive monomer diluents and one or more polyfunctional reactive monomer diluents can be used. Reactive monomer diluents include unsaturated addition-polymerizable monofunctional and polyfunctional acrylic monomers. Alkoxylated and non-alkoxylated acrylic monomers are useful reactive diluents and are well known. Particular examples of alkoxylated acrylic monomers contain from 2-14 alkoxy repeating units. Examples of acrylic monomers include (but are not limited to) isobornyl acrylate, phenoxyethyl acrylate, isodecyl acrylate, hexyl acrylate, cyclohexyl acrylate, 2-ethylhexyl acrylate, octyl acrylate, nonyl acrylate, stearyl acrylate, 2-phenoxy acrylate, 2-methoxyethyl acrylate, lactone modified esters of acrylic and methacrylic acid, methyl methacrylate, butyl acrylate, isobutyl acrylate, methacrylamide, allyl acrylate, tetrahydrofuryl acrylate, n-hexyl methacrylate, 2-(2-ethoxyethoxy)ethyl acrylate, n-lauryl acrylate, 2-phenoxyethyl acrylate, glycidyl methacrylate, glycidyl acrylate, acrylated methylolmelamine, 2-(N,N-diethylamino)-ethyl acrylate, neopentyl glycol diacrylate, alkoxylated neopentyl glycol diacrylate, ethylene glycol diacrylate, hexylene glycol diacrylate, diethylene glycol diacrylate, dipropylene glycol diacrylate, tripropylene glycol diacrylate, tetraethylene glycol diacrylate, pentaerythritol di-, tri-, tetra-, or penta-acrylate, trimethylolpropane triacrylate, alkoxylated trimethylol-propane triacrylate which contains from 2 to 14 moles of either ethylene or propylene oxide, triethylene glycol diacrylate, tetraethylene glycol diacrylate, alkoxylated neopentyl glycol diacrylate having from 2 to 14 moles of ethoxy or propoxy units, polyethylene glycol diacrylate, 1,3-butylene glycol diacrylate, 1,4-butanediol diacrylate, 1,6-hexanediol diacrylate, polyethylene glycol diacrylate, combinations thereof, and any corresponding methacrylates, as well as mixtures of any of the above. For additional examples of potentially useful (meth)acrylates reference can be made to commonly assigned U.S. Pat. No. 6,713,548.

Other examples of (meth)acrylate reactive diluents are the multifunctional acrylates with number average molecular weights of about 200 to about 2000. Examples of such are tetraethylene glycol diacrylate with a molecular weight of about 302, ethoxylated bisphenol-A diacrylate with a number average molecular weight of about 776 (SR602 from Sartomer Company), trihydroxyethyl isocyanurate triacrylate with number average molecular weight of about 425 (SR368 from Sartomer), trimethylol propane triacrylate with a number average molecular weight of about 300 (SR351 from Sartomer), and ethoxylated trimethylol propane triacrylates with number average molecular weights from about 400 to about 2000 (SR454, SR499, SR502, SR9035, and SR 415 from Sartomer Company and Photomer 4155 and Photomer 4158 from Henkel Corporation).

In one embodiment of the invention, the reactive monomer and/or oligomer is present in the impregnating resin composition in an amount of about 10 to about 100% by weight of the radiation-curable impregnating composition. In another embodiment, the reactive diluent is present in an amount of about 15 to about 85%. In still another embodiment it is present in an amount of about 40 to about 75% by weight of the radiation-curable coating composition.

The term “radiation” as used herein includes any form of electromagnetic radiation or electron beam. In particular it includes UV, visible and infrared radiation and electron beam radiation. The radiation curable impregnating resin compositions may contain a photoinitiator to allow for curing of the polymer material. However compositions without photoinitiators may be cured using electron beam radiation. The photoinitiator can be by any of the known photoinitiators. These compounds absorb the exposure radiation and generate a free radical alone or in conjunction with a sensitizer. Conventionally, there are homolytic photoinitiators which cleave to form two radicals and initiators which radiation converts to an active species which generates a radical by abstracting a hydrogen from a hydrogen donor. There are also initiators which complex with a sensitizer to produce a free radical generating species and initiators which otherwise generate radicals in the presence of a sensitizer. Both types can be used. If the system relies upon ionic polymerization to tie up the chromogen, the initiator may be the anion or cation generating type depending on the nature of the polymerization. Where, for example, ultraviolet sensitivity is desired, suitable photoinitiators include alpha-alkoxy phenyl ketones, O-acylated alpha-oximinoketones, polycylic quinones, benzophenones and substituted benzophenones, xanthones, thioxanthones, halogenated compounds such as chlorosulfonyl and chloromethyl polynuclear aromatic compounds, chlorosulfonyl and chloromethyl heterocyclic compounds, chlorosulfonyl and chloromethyl benzophenones and fluorenones, haloalkanes, photoreducible dye-reducing agent redox couples, halogenated paraffins (e.g., brominated or chlorinated paraffin) and benzoin alkyl ethers.

Representative examples of photoinitiators include benzophenone, benzoin, acetophenone, benzoin methyl ether, Michler's ketone, benzoin butyl ether, xanthone, thioxanthone, propiophenone, fluorenone, carbozole, diethyoxyacetophenone, 1-hydroxy-cyclohexyl phenyl ketone, the 2-, 3- and 4-methylacetophenones and methoxyacetophenones, the 2- and 3-chloroxanthones and chlorothioxanthones, 2-acetyl-4-methylphenyl acetate, 2,2′-dimethyoxy-2-phenylacetophenone, benzaldehyde, fluorene, anthraquinone, triphenylamine, 3- and 4-allyl-acetophenone, p-diacetylbenzene, 3-chloro-2-nonylxanthone, 2-chlorobenzophenone, 4-methoxybenzophenone, 2,2′,4,4′-tetrachlorobenzoph-enone, 2-chloro-4′-methylbenzophenone, 4-chloro-4′-methylbenzophenone, 3-methylbenzophenone, 4-tert-butyl-benzophenone, isobutyl ether, benzoic acetate, benzil, benzilic acid, amino benzoate, methylene blue, 2,2-diethoxyacetophenone, 9,10-phenanthrenequinone, 2-methyl anthraquinone, 2-ethyl anthraquinone, 1-tert-butyl-anthraquinone, 1,4-naphthoquinone, isopropylthioxanthone, 2-chlorothioxanthone, 2-iso-propylthioxanthone, 2methylthioxanthone, 2-decylthioxanthone, 2-dodecyl-thioxanthone, 2-methyl-1-[4-(methyl thio)phenyl)]-2-morpholinop-ropanone-1, combinations thereof and the like.

The photoinitiator or combination of photoinitiators is typically utilized in an amount ranging from about 0.5 to about 20 wt. %. In another embodiment it is used in an amount of about 1 to about 10 weight % of the radiation-curable impregnating composition. The photoinitiators may be used alone or in combinations. Combinations of initiators are desirable to provide uniform depthwise cure of the overlay. In one embodiment it has been found that the combination of benzophenone and benzyl dimethyl ketal provides both surface and depth or bulk cure.

For examples of UV curable compositions useful in certain embodiments of the invention refer to the disclosures of U.S. Pat. Nos. 4,600,649; 4,900,763; and 4,065,587. In one particular embodiment of the invention there is provided an abrasion resistant overlay, particularly for wood floor applications, wherein the impregnating composition comprises mono-olefin functional and multi-olefin functional polyurethane monomers, oligomers and polymers. In accordance with another embodiment, the impregnating resin may contain an acrylate which is modified by polymerisable nanoparticles as described in U.S. Pat. No. 6,663,952. In accordance with still another embodiment of the invention, the impregnating resin composition is a radiation curable mixture of a hydrophilic polymer such as 400-1000 weight average molecular weight polyethylene glycol and a reactive monomer such as an ethylenically unsaturated addition polymerizable monomer. Examples of such mixtures are provided in U.S. Published Application 2004/0038062.

Urethane acrylates are also useful as radiation curable impregnating resin compositions. One example of a urethane acrylate is described in U.S. Pat. No. 5,843,576 and is formed from a (meth)acrylate reactive diluent having a number average molecular weight of at least 200 and less than about 2000, and the reaction product of a polyisocyanate with about 3 to 6 isocyanate functionalities per molecule, an aromatic polyester polyol and a hydroxyalkyl(meth)acrylate with a number average molecular weight of about 344 to 472.

In one embodiment of the invention, the radiation curable composition includes a reactive silicone acrylate oligomer. Representative examples of silicone acrylate oligomers useful in various embodiments of the present invention include but not limited to (3-acryloxypropyl)trimethoxysilane, 3-methacryloxypropyltrimethoxysilane, N-(-3-(meth)acryloxy-2-hydroxypropyl)-3-aminopropyltriethoxysilane, methacryloxypropyltriethoxysilane, methacryloxymethyltriethoxysilane, methacryloxymethyltrimethoxysilane, (3-acryloxypropyl)methyldimethoxysilane, methacryloxypropylmethyldiethoxysilane, methacryloxypropylmethyldimethoxysilane, methacryloxypropyldimethylethoxysilane, methacryloxypropyldimethylmethoxysilane, allyltrimethoxysilane, 3-(N-styrylmethyl-2-aminoethylamino)-propyltrimethoxysilane, vinyltrimethoxysilane, vinyltriethoxysilane, vinyltriacetoxysilane, vinyltriisopropenoxysilane, vinyltriisopropoxysilane, vinyltrimethoxysilane, vinyltris(2-methoxyethoxy)silane, vinyltris(methylethylketoximino)silane, allyloxyundecyltrimethoxysilane, 3-butenyltriethoxysilane, 2-(chloromethyl)allyltrimethoxysilane, docosenyltrethoxysilane, 7-octenyltrimethoxysilane, o-(propargyloxy)-N-)triethoxysilylpropyl)urethane, styrylethyltrimethoxysilane, vinyltri-t-butoxysilane, vinyltris(methoxypropoxy)silane, vinylmethyldiethoxysilane, vinylmethyldimethoxysilane, vinyldimethylethoxysilane, trivinylmethoxysilane, bis(triethoxysilyl)ethylene, bis(trimethoxysilylmethyl)ethylene, N-allyl-aza-2,2-dimethoxysilacyclopentane, and 3-(N-allylamino)propyltrimethoxysilane.

In formulating a radiation curable composition for use in the invention, the monomers are selected so as to provide a wear layer which has the desirable balance of properties including abrasion resistance, strength, hardness, brittleness and which possess a viscosity which is suitable for impregnation into the paper at ambient temperature, preferably without the application of a vacuum. Polyfunctional acrylates provide increased crosslinking and are often incorporated in the composition to increase the hardness of the overlay wear layer. Monomers having ring structures, such as carbocylic or heterocyclic aliphatic or aromatic rings, e.g., isocyanurate triacrylate and melamine acrylate are added to increase hardness but also can introduce undesirable brittleness. The cyclic acrylate can include a cycloaliphatic or an aromatic ring having about 5 to 7 and most typically 6 atoms which may be carbon or a heteroatom such as nitrogen or oxygen. In order to modify the hardness and brittleness of the overlay which accompanies the use of polyfunctional and cyclic monomers typically alkoxylate monomers are added to the formulation to impart a degree of softness or flexibility to the wear layer. Typical examples of alkoxylated monomers are provided above. Alkoxylated monomers may be monofunctional or polyfunctional and contain about 1 to 15 carbon atoms in the alkoxy group.

In accordance with certain embodiments of the invention, the saturating resin formulation is adjusted to provide composite overlays having a hardness of approximately 3 H to 9 H and in other embodiments about 6 H to 8 H. In accordance with certain embodiments of the invention, the resin is formulated to provide an abrasion resistance of approximately 0.01 to 0.08 and in other embodiments about 0.03 to 0.05. As used herein, abrasion resistance is measured in accordance with ASTM D-4060 wear index. In the pencil hardness test, a series of pencils of increasing hardness values are rolled across the overlay substrates for each tested pencil hardness. The coatings were rated based on the highest pencil hardness that did not scratch or dent the coating. Higher pencil hardness values thus indicate superior film hardness. Desirably a coating should have better than a 3 H rating. Scratch hardness may also be measured in accordance with ISO 4586-2. Using this test, in one embodiment, scratch hardness is about 1.5 to 3.5 Newtons.

It has been found advantageous to add the reactive silicone acrylate to the composition to enhance adhesion to the substrate as well as to enhance intercoating adhesion (e.g., in embodiments where more than one coating is provided on the substrate as the wear layer. It is believed that the silanyl groups in the silicone acrylate react with hydroxy groups in the underlying wood or vinyl substrate. Hydroxy groups are present in the wood in the form of cellulose molecules and they are introduced into vinyl in the form of limestone fillers.

In accordance with a more particular embodiment of the invention, the radiation cured resin composition includes: (i) a monofunctional or polyfunctional cyclic acrylate such as isocyanurate triacrylate and melamine acrylate; (ii) an alkoxylated acrylate, and (iii) a reactive silicone acrylate oligomer. The cyclic acrylate may be present in an amount of about 1 to 40% by weight based on the total monomer composition in one embodiment and in an amount of about 10 to 30% in another embodiment, the alkoxylated acrylate may be present in an amount of about 5 to 85% by weight in one embodiment and in an amount of about 25 to 70% in another embodiment, and the reactive silicone acrylate oligomer may be present in an amount of about 0.1 to 25% in one embodiment and in an amount of about 1 to 12% in another embodiment.

In accordance with one embodiment of the invention, the radiation curable resin compositions are impregnated into a overlay paper and bonded to a substrate or base layer as illustrated in the following examples. In another embodiment, however, the radiation curable compositions can be applied directly to the substrate without impregnating a paper overlay. For example, the coatings can be spray coated, roll coated or applied with a blade or wiper to the surface of the substrate and cured by exposure to radiation, such as exposure to ultraviolet radiation of an intensity sufficient to cure the coating in one or more exposures. The coatings may be applied to the substrate in any suitable thickness effective in protecting the substrate against wear, such as, thicknesses of about 0.2 to 0.8 mil.

The examples set forth below represent embodiments of the abrasion resistant laminate of the present invention and methods for making this laminate and are not intended to be limiting. Varying amounts, types and or thicknesses of the components of the laminate may be used in the invention.

### EXAMPLE 1

Experimental

Lab Preparation of Overlay Papers Bonded to Resin: Samples (6″×6″) of wear resistant overlay paper having a basis weight of 33 or 45 grams per square meter (gsm) at 18% or 30% 70 μm average diameter white electrofused alumina were placed in a vacuum flask with 1 liter of Hauthane HD 2209 or HD 2107 polyester-aliphatic polyurethane dispersion at 35% solids or a 50:50 blend of HD2209 and MeadWestvaco Specialty Chemicals' acrylic. House vacuum was applied and released sequentially about 3 times to fully degass the solution and infiltrate the paper matrix.

The wet saturated sheet of overlay paper was removed from the flask and laid felt side down on one of the following the base layers: (1) Black Glosstech 5 Vinyl Film Base bonded to a melamine resin saturated and b-stage cured white barrier film (the barrier film provides a white rigid background for observing the wear); (2) Armstrong Excelon VCT, or (3) Homogeneous Vinyl. Excess resin and air bubbles were removed by rolling over the sample with a smooth round #0 Meyer rod. The sample was allowed to air dry and self cure for 1 hour at room temperature. The dry resin pick up by the sample was in the range of 100 to 150% of the weight of the paper. The sample firmly and uniformly bonded to the vinyl surface giving a dry transparent film of low gloss.

Scuff resistance was measured by BYK Gardner Scuff Tester Model AG-8100 using Norton UPC code 66261126339 P100-J grit sandpaper. Gloss at 60° was measured after every 10 scuffs. The results are shown in Table 1.

Taber abrasion resistance was measured by the grit feeder weight loss method (ASTM F-510). The results are shown in Table 2.

The sample was cut into a 4″×4″ square and tested for abrasion resistance by the initial point/end point (IP/EP) method described in International Standard EN 438-2. The abrasion resistance is reported in Table. Transparency of the saturated and bonded overlay was measured by optical density over black vinyl with a X-Rite Model 518LP Spectrodensitometer. Values close to 2.0 or higher were considered to be excellent in clarity. Values below 1.8 were considered fair to poor.

TABLE 1
Scuff Test

| | | | Scuffs/ | | |
|---|---|---|---|---|---|
| | | | Point | Scuffs to | |
| | Gloss | | Gloss | 50% | % |
| Sample | Initial | Final | Loss | Gloss | Improve |
| Scuffs | 0 | 50 | | | |
| Armstrong Excelon VCT | | | | | |
| Uncoated Control | 6.2 | 3.1 | 16 | 50 | |
| Saturated 33 gsm WROL | 5.8 | 4.1 | 29 | 85 | 71% |
| 50:50 Acrylic/Polyurethane | | | | | |
| Benchmark WearMax (TM) | 22.7 | 6.2 | 3 | 34 | −31% |
| Coating no paper | | | | | |
| Homogeneous Vinyl | | | | | |
| Uncoated Control | 5.2 | 3.2 | 25 | 65 | |
| Saturated 33 gsm WROL | 6.4 | 4.8 | 31 | 100 | 54% |
| Polyurethane only | | | | | |

TABLE 2
Taber Abrasion Resistance by the Grit Feeder Method (ASTM F-510)

| | Weight Loss | % |
|---|---|---|
| | 1,000 cycles | Improve |
| Armstrong Excelon VCT | | |
| Uncoated Control | 0.0853 | |
| Saturated 33 gsm WROL | 0.0511 | 40% |
| 50:50 Acrylic/Polyurethane | | |
| Benchmark WearMax (TM) | 0.0370 | 57% |
| Coating no paper | | |
| Homogeneous Vinyl | | |
| Uncoated Control | | |
| Saturated 33 gsm WROL | 0.0173 | 58% |
| Polyurethane only | | |

TABLE 3
Abrasion Resistance by the IP/EP Method (EN 438-2)

| | | Grams per | Grams per | | Transparency |
|---|---|---|---|---|---|
| | | m\hat{ }2 | m\hat{ }2 | | by |
| Black Glosstech 5 Vinyl | | Polyurethane | Fused | Grit Size | Optical |
| Film Base | Cycles | Resin | Alumina | um | Density |
| Conrol (no coating or | 325 | 0 | 0 | — | 2.55 |
| overlay) | | | | | |
| Hauthane 2107 saturated | 1460 | 60 | 13.5 | 70 | 1.82 |
| 45 gsm WROL | | | | | |
| Hauthane 2209 saturated | 1350 | 73 | 13.5 | 70 | 2.02 |
| 45 gsm WROL | | | | | |
| Hauthane 2209 saturated | 950 | 97 | 0 | — | 1.58 |
| 42 gsm overlay | | | | | |
| Hauthane 2209 saturated | 650 | 53 | 0 | — | 1.86 |
| 23 gsm overlay | | | | | |
| Benchmark WearMax | 1150 | 120 | 13.5 | 50 | 2.12 |
| (TM) Coating no paper | | | | | |

Results showed a 50-70% improvement in scuff resistance and a 40-60% improvement in abrasion resistance with the Hauthane 2209 saturated WROL wear layer by the weight loss method. Wearmax Ceramic Armor after market coating alone only showed improvement abrasion resistance (60%). The blend of acrylic and polyurethane worked better for scuff resistance (gloss retention) than polyurethane alone because the acrylic polymer contributes to maintaining gloss.

Abrasion resistance measured by the initial point/end point method showed that fused alumina was critical to obtaining high abrasion levels. Both the WROL paper and benchmark polyurethane coating containing grit (WearMax) could deliver high abrasion, but saturated paper without grit (42 and 23 gsm) could not.

Stain testing and water immersion testing (4 hours) were also done. The only sample that showed any staining (betadine, catsup and mustard) was control uncoated white homogeneous vinyl (mustard). Samples with the acrylic resin in the saturant showed some cloudiness after 4 hours of immersion in cold water. Samples with the polyurethane alone showed no effect of water immersion. All samples remained bonded during the water immersion test.

### EXAMPLE 2

Engineered wood flooring samples, both UV-cured polyurethane finished (6 layers) and unfinished 600 um veneer on HDF, belonging to the Par-Ky brand of Decospan were obtained from Europe. Samples were laminated with melamine resin saturated transparent overlay (45 gsm paper containing 30% fused alumina) prepreg felt side down at 320° F., 500 psi, for 2.5 minutes and cooled for 8 minutes before opening the press. Similar scuff and abrasion tests were performed as described in Example 1 above. Results are shown in Table 4.

TABLE 4
Abrasion Resistance by the IP/EP Method

| | | | Scuff | |
|---|---|---|---|---|
| | Abrasion | | Resistance | |
| Par-Ky Base | Resistance | % | Cycles to | % |
| Wood Veneer | Cycles | Improve- | 50% | Improve- |
| Flooring on HDF | (IP + EP)/2 | ment | Gloss Loss | ment |
| Control (no coating | 700 | — | 8 | — |
| or overlay) | | | | |
| Melamine Resin | 4200 | 600% | 55 | 688% |
| saturated 45 gsm | | | | |
| WROL | | | | |
| Par-Ky with | 1100 | 157% | 36 | 450% |
| commercial 6-layer | | | | |
| UV-cured | | | | |
| Polyurethane | | | | |

Results from the table above show that lamination of a melamine saturated wear resistant paper overlay to wood veneer flooring gives at least a six-fold improvement in abrasion and scuff resistance in a single layer while the 6-layer polyurethane gives a two to four fold improvement. Similar results are expected with saturated wear resistant overlay prepared by alternate grit addition technologies (liquid overlay, etc, EP 1216759, U.S. Pat. No. 6,231,670, U.S. Pat. No. 6,432,201, U.S. Pat. No. 6,471,776, U.S. Pat. No. 6,558,754, U.S. 20030010285, etc.)

Dimensional Stability

Difficulties in forming a clear vinyl wear layer on a foamed vinyl base without wrinkles, curling, cupping, doming and buckles have been an issue with vinyl products such as flooring. Loose lay type flooring, because it is not reinforced by attachment to the floor, has even more tendency to form these defects when heavy furniture is rolled over the surface. A further advantage of certain embodiments of the present invention is that the saturated paper wear layer adds dimensional stability that resists the tendency toward these problems. Evidence of this effect comes from tensile measurements of the wear layer polymer with and without paper.

In order to evaluate the dimensional stability obtained with saturated paper overlays versus conventional wear-resistant coatings alone, tensile testing was done comparing free films of HD 2209 and a saturated overlay of HD 2209. Comparison of the dimensional strength of a polyurethane and polyurethane saturated WROL paper was done by casting the saturated overlay or polymer alone on a silicone based release paper and peeling off after curing. Free film strength was measured in an Instron tensile tester. The results are shown in Table 5 below.

Results showed that the saturated overlay was 4 to 5 times stronger (load/width at max) than the polymer film alone and 2 to 3 times stronger than the paper alone.

### EXAMPLE 3

A UV cured composition was prepared as follows: To a vial covered with aluminum foil, 5 parts of benzophenone, 5 parts of benzyl dimethyl ketal and 27 parts of a propoxylated neopentyl glycol diacrylate (SR9003B manufactured by Sartomer) were mixed with stirring. The mixture was heated to 55° C. After dissolution, 13.5 parts of melamine acrylate (Actilane 890 manufactured by Akzo Nobel), 13.5 parts of isocyanurate triacrylate (SR368 manufactured by Sartomer), 6 parts of ethoxylated pentaerythritol tetraacrylate (SR494 manufactured by Sartomer) and 30 parts of alkoxylated triacrylate (CD501 manufactured by Sartomer) were added to the vial. After a cooling down period, 10 parts of methacryloxypropyl-tris-(-2-propoxy)silane (CoatOSil® 1757 manufactured by GESilicones) were added to the latter mixture. The resulting UV curable formulation was applied onto wood or VCT. The coated substrates were placed and cured on the conveyer of a 6 inch Fusion System V-curer and at a speed of 18 feet per minute and irradiated to cure the coating. Full (tack-free) cure was obtained after 2 passes.

In accordance with one embodiment of the invention, the UV curable formulation described above was impregnate into a 14 lb (33gsm) overlay paper and applied to the surface of an engineered wood substrate and fully cured under on a Fusion System V-curer under the conditions described above.

### EXAMPLE 4

A UV cured composition was prepared as follows: To a vial covered with aluminum foil, 5 parts of benzophenone, 5 parts of benzyl dimethyl ketal and 27 parts of a propoxylated neopentyl glycol diacrylate (SR9003B manufactured by Sartomer) were mixed with stirring. The mixture was heated to 55° C. After dissolution, 13 parts of melamine acrylate (Actilane 890 manufactured by Akzo Nobel), 13 parts of isocyanurate triacrylate (SR368 manufactured by Sartomer), 6 parts of ethoxylated pentaerythritol tetraacrylate (SR494 manufactured by Sartomer) and 26 parts of alkoxylated triacrylate (CD501 manufactured by Sartomer) were added to the vial. After a cooling down period, 5 parts of metallic acrylate (CN2404 manufactured by Sartomer) were added to the latter mixture. The resulting UV formulation was applied onto wood or VCT. The coated substrates were placed on the conveyer of a 6 inch Fusion System V-curer at 18 feet per minute and irradiated to cure the coating. Full (tack-free) cure was obtained after 2 passes.

### EXAMPLE 5

A UV cured composition was prepared as follows: To a vial covered with aluminum foil, 5 parts of benzophenone, 5 parts of benzyl dimethyl ketal and 27 parts of a propoxylated neopentyl glycol diacrylate (SR9003B manufactured by Sartomer) were mixed with stirring. The mixture was heated to 55° C. After dissolution, 26 parts of isocyanurate triacrylate (SR368 manufactured by Sartomer), 6 parts of ethoxylated pentaerythritol tetraacrylate (SR494 manufactured by Sartomer) and 26 parts of alkoxylated triacrylate (CD501 manufactured by Sartomer) were added to the vial. After a cooling down period, 5 parts of metallic acrylate (CN2404 manufactured by Sartomer) and 10 parts of methacryloxypropyl-tris-(-2-propoxy)silane (CoatOSil® 1757 manufactured by GESilicones) were added to the latter mixture. The resulting UV formulation was applied onto wood or VCT. The coated substrates were placed on the conveyer of a 6 inch Fusion System V-curer at 18 feet per minute and irradiated to cure the coating. Full (tack-free) cure was obtained after 2 passes.

Having described the invention in detail and by reference to specific embodiments thereof, it will be apparent that numerous variations and modifications are possible without departing from the spirit and scope of the invention as defined by the following claims.

1. A laminar product comprising an overlay and a base layer, the overlay including a fibrous web impregnated with a saturating resin, the base layer being a resilient resin layer, a felt or matted layer, or a wood layer, the saturating resin being a radiation curable resin.

2. The laminar product of claim 1 wherein the fibrous web is a cellulose web.

3. The laminar product of claim 2 wherein the saturating resin is a radiation curable composition containing an ethylenically unsaturated compound curable through free radical induced polymerization.

4. The laminar product of claim 3 wherein, when cured, the overlay provides a hardness of about 3 H to 9 H and/or an abrasion resistance of about 0.01 to 0.08.

5. The laminar product of claim 3 wherein the radiation curable composition includes a silicone acrylate oligomer.

6. The laminar product of claim 5 wherein the radiation curable composition further includes a cyclic polyfunctional acrylate compound.

7. The laminar product of claim 6 wherein the radiation curable composition additionally includes an alkoxylated acrylate compound.

8. The laminar product of claim 3 wherein the radiation curable composition additionally includes a reactive diluent.

9. The laminar product of claim 7 wherein the cyclic acrylate compound is be present in an amount of about 1 to 40% by weight, the alkoxylated acrylate is present in an amount of about 5 to 85%, and the silicone acrylate is present in an amount of about 0.1 to 25% based on the total weight of the radiation curable composition.

10. The laminar product of claim 5 wherein the overlay includes a wear-resistant pigment.

11. The laminar product of claim 10 wherein the base layer is a resilient layer containing a vinyl resin.

12. The laminar product of claim 10 wherein the base layer includes a foamed polymeric layer and a felt or mat layer, wherein the foamed polymeric layer is interposed between the felt layer and the overlay.

13. The laminar product of claim 10 wherein the base layer is wood flooring.

14. The laminar product of claim 10 wherein the wear-resistant pigment is rounded quartz or fused alumina.

15. The laminar product of claim 10 wherein the cellulose web includes alpha cellulose.

16. The laminar product of claim 15 wherein the overlay has a basis weight of about 17 to 30 lbs per 3,000 square feet.

17. The laminar product of claim 10 wherein the laminate is suitable for use as flooring.

18. The laminar product of claim 13, wherein the wood flooring is engineered wood flooring or wood veneer flooring

19. A laminar flooring product comprising a base layer of wood and an overlay overlying the base layer, the overlay including a paper web impregnated with a saturating resin, the saturating resin being a radiation curable resin, wherein the resin includes a reactive silicone acrylate oligomer.

20. The laminar product of claim 10 wherein the base layer is a composite of limestone and a vinyl resin.

21. A radiation curable composition comprising a silicone acrylate and a cyclic polyfunctional acrylate.

22. The composition of claim 21 further comprising an alkoxylated acrylate.

23. The composition of claim 22 wherein the cyclic acrylate compound is present in an amount of about 1 to 40% by weight, the alkoxylated acrylate is present in an amount of about 5 to 85%, and the silicone acrylate is present in an amount of about 0.1 to 25% based on the total weight of the radiation curable composition.

24. The composition of claim 23 wherein the radiation curable composition additionally includes a reactive diluent.

25. The composition of claim 21 wherein the radiation curable composition additionally includes at least one photoinitiator.

26. The composition of claim 21 wherein the radiation curable composition is formulated such that when cured in an overlay, the cured and saturated overlay provides a hardness of about 3 H to 9 H and/or an abrasion resistance of about 0.01 to 0.08.

27. The composition of claim 23 wherein alkoxylated monomers may be monofunctional or polyfunctional and contain about 1 to 15 carbon atoms in the alkoxy group

28. A method for applying a wear layer to a substrate comprising applying a radiation curable composition including a silicone acrylate and a cyclic polyfunctional acrylate to the surface of the substrate, and exposing the layer to actinic radiation to cure the layer.

29. The method of claim 28 wherein the radiation curable composition is first impregnated into a paper web and the impregnated paper web is applied to the surface of the substrate.
